(19) United States
(12) Patent Application Publication
(10) Pub. No.: US 2018/0278552 A1
(43) Pub. Date: Sep. 27, 2018

(54) ACCESSING CHAT SESSIONS VIA CHAT BOTS FOR MULTI-USER AUTHORIZATION OF TRANSACTIONS

(71) Applicant: PAYPAL, INC., San Jose, CA (US)

(72) Inventors: Dereck Quock, Santa Clara, CA (US); Bhavishyavani Ravi, Los Angeles, CA (US); Jennifer Esmeralda Delaney, Mountain View, CA (US); Kurt Weiberth, Sunnyvale, CA (US); Soujanya Karthik Kastury, San Jose, CA (US)

(21) Appl. No.: 15/464,990

(22) Filed: Mar. 21, 2017

(51) Int. Cl. H04L 12/58; H04L 29/08; H04L 29/06; G06Q 20/40; G06Q 20/22; G06Q 20/38

(52) U.S. Cl. CPC H04L 51/02; H04L 51/046; H04L 67/306; H04L 65/1069; H04L 63/083; G06Q 20/4016; G06Q 20/223; G06Q 20/3821; G06Q 20/405

(57) ABSTRACT

A method for multi-user authorization of transactions via chat sessions is discussed. The method includes accessing, via a chat bot, a chat text in a chat session by a first chat application instance of a first device to a second chat application instance of a second device. The method includes determining, based on analysis of the chat text, onboarding intent of a transaction originating at the second device, the onboarding intent indicating that the transaction be performed at a payment system. Responsive to determining the onboarding intent, the method determines whether user of the first chat application instance has an account at the payment system. Responsive to determining that the user has the account at the payment system, communication is transmitted to the second device prompting the second device to authorize the chat bot to obtain authorization credentials, from the first device, for the transaction.

### TECHNICAL FIELD

Embodiments of the present disclosure generally relate to the field of communication systems and, more particularly, to communicating in chat sessions using chat bots.

### BACKGROUND

Chat sessions facilitate communication between chat applications in a communication system. A user of a chat application can communicate, over a communication network, with a user of another chat application by transmitting communication to, and receiving communication from, the chat session. A chat bot can simulate a chat application to communicate with other chat applications using the chat session.

A payment system can be used for facilitating payments for online purchases and for managing financial information. Some users may have difficulty with setting up an account at a payment system for facilitating payments for online purchases and for managing financial information. Some of these users, even if they set up an account at the payment system, can have problems with using such a payment account, e.g., they may be unable to complete an online purchase. Certain users can have difficulty with providing authorization credentials needed for using these payment account, such as with providing payment account authorization needed to complete online purchase. These users may find it frustrating when needing to use payment systems, and may be discouraged from using the payment system for making online purchases, or even stop using the payment system altogether.

### BRIEF DESCRIPTION OF THE DRAWINGS

The present embodiments may be better understood, and numerous objects, features, and advantages made apparent to those skilled in the art by referencing the accompanying drawings.

FIG. 1 is a system diagram illustrating embodiments of a communication system showing a bot application communicating using a chat session.

FIG. 2 is a flow diagram illustrating embodiments of operations for accessing chat sessions for multi-party authorization of a user transaction initiated at a single device.

FIGS. 3 and 4 illustrate embodiments of communication for accessing chat sessions for multi-party authorization of a user transaction initiated at a single device.

FIG. 5 is a timing diagram illustrating embodiments of communication between a bot application and chat application instances via a chat session for multi-party authorization of user transactions initiated at a single user device.

FIG. 6 is a block diagram of one embodiment of an electronic device used in the communication systems of FIGS. 1 and 5.

### DESCRIPTION OF EMBODIMENT(S)

The description that follows includes exemplary systems, methods, techniques, instruction sequences, and computer program products that embody techniques of the present disclosure. However, it is understood that the described embodiments may be practiced without these specific details. For instance, although some examples refer to social media services, other types of media services are contemplated, such as online news services, other blogs, and/or other websites that can receive communication from users, and also facilitate displaying of content of such communication.

Chat sessions facilitate communication between instances of chat applications running on various devices in a communication system. A user of one instance of a chat application can communicate, over the communication system, with a user of another instance of a chat application by transmitting and receiving communication to/from the chat session. For example, the communication system facilitates the transmission of chat texts, over a communication network, between the instances of the chat applications and the chat session. The chat session, which can be hosted by a chat service, can facilitate communication between the multiple instances of the chat applications. Each chat application, such as a SLACK chat application, or a FACEBOOK MESSENGER application, can be hosted by a user device. In some cases, the communication may be between multiple instances of the same type of chat application. In other cases, the communication may involve instances of multiple different types of chat applications. The user device can be any type of a personal device such as a mobile phone, tablet, or other computing device.

Thus, for example, multiple SLACK chat application instances can communicate with each other by transmitting chat texts to, and receiving chat texts from, a SLACK chat session. The chat service can be a part of a social media service. For example, the chat service can be a SLACK chat service that is a part of a SLACK team collaboration tool, or a FACEBOOK MESSEGENGER chat service that is a part of a FACEBOOK® social networking service. The chat service itself can be further hosted by a server or another type of a computing device.

A bot application can communicate, via a chat bot, with the chat session and simulate a chat application instance for communicating with the other chat application instances. For example, the bot application may simulate a SLACK chat application instance for communicating, via a SLACK chat session, with other SLACK chat application instances. The chat bot can send and receive chat texts from the chat session.

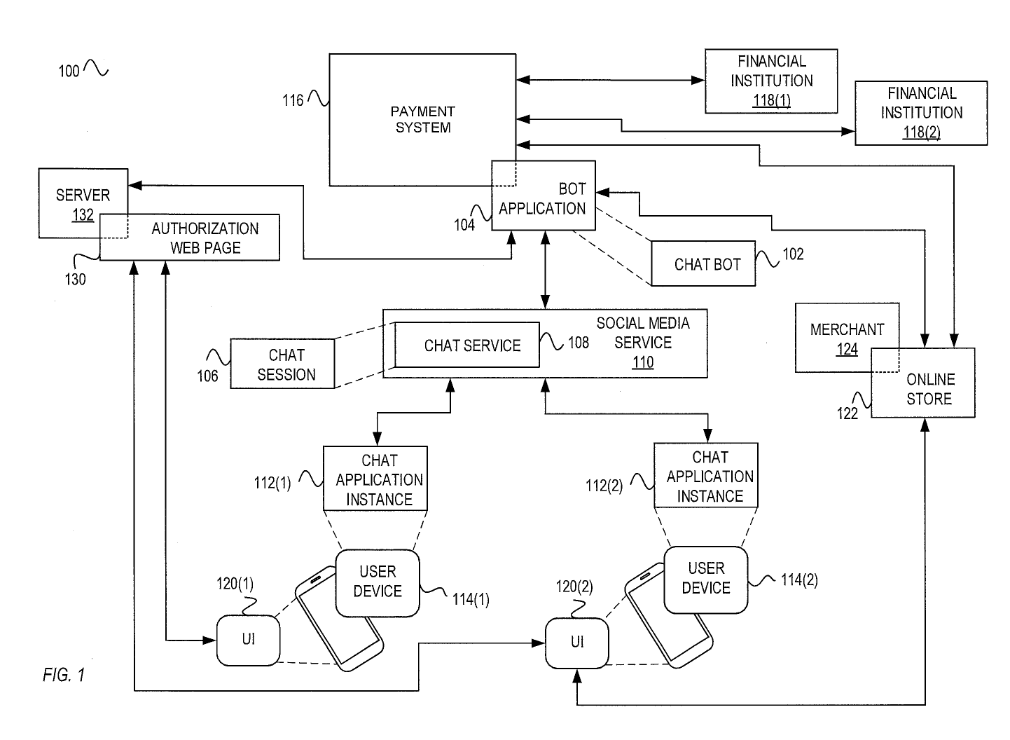

A user may also attempt to set up an account at a payment system. As discussed in more detail with reference to FIG. 1, a payment system can be used for facilitating payments for online purchases and for managing financial information. However, some users can have difficulties with providing authorization credentials needed for authorizing and/or using such a payment account. Furthermore, some of the users can have problems with using such payment accounts, e.g., they may be unable to complete an online purchase.

In some embodiments, a chat bot can access a chat text in a chat session that is hosted by a chat service. The chat text can be provided by a chat application instance of an existing user device to another chat application instance of a new user device. A bot application can analyze the chat text, and based on this analysis, determine whether the chat text indicates an onboarding intent of a transaction originating at the new user device. The onboarding intent can indicate that the transaction is to be performed at a payment system. Responsive to determining the onboarding intent, the bot application can determine whether a user of the first chat instance has an account at the payment system. If the bot application determines that the user has a payment account at the payment system, the bot application can transmit communication to the second device. This communication can prompt the second device to authorize the chat bot of the bot application to obtain authorization credentials from the existing user device for the user transaction.

The user transaction can be a purchase transaction that originates at the new user device for an online purchase at the merchant. In this case, the communication can include purchasing details for accessing a webpage of the online merchant. The user transaction can be an onboarding transaction originating at the new user device for onboarding the new user onto the payment system. In this case, the communication can include authorization credentials of the new user. The following description, and associated Figures, illustrates various embodiments directed to the ideas listed above.

FIG. 1 is a system diagram 100 illustrating some embodiments of a communication system showing a bot application communicating using a chat session. In an overview of the system diagram 100, a chat bot 102 is hosted by a bot application 104. The bot application 104 communicates, via the chat bot 102, with a chat session 106. The chat session 106 is hosted by a chat service 108, which in turn is hosted by a social media service 110. Chat application instances 112(1) and 112(2) (e.g., instances of the same type of chat application, instances of more than one type of chat application) can communicate with each other via the chat session 106. For example, the chat application instance 112(1) can transmit a chat text to the chat session 106 for access by the chat application instance 112(2). The chat bot 102 simulates a chat application instance when communicating with the chat application instances 112(1) and 112(2). Each of the chat application instances 112(1) and 112(2) may be hosted by a respective user device 114(1) and 114(2). For example, the chat application instance 112(1) is hosted by the user device 114(1). Each of the user devices 114(1) and 114(2) can also display a user interface (UI) 120(1) and 120(2), respectively. Each of the UIs 120(1) and 120(2) can display visual elements, such as chat texts of the chat session 106. Each of the UIs 120(1) and 120(2) can also receive input from a user, such as a selection from a user. It is noted that each of the user devices 114(1) and 114(2) can also receive input from a user via other input elements, such as via a keyboard, mouse, microphone (e.g., from a voice command), among others.

A service or an application (such as the bot application 104) can be hosted by a combination of software and hardware. It is noted that the same term “hosting” is used herein to describe both software hosting and hardware hosting. When software hosting, a software service such as the chat service 108, can instantiate and manage multiple chat sessions, such as the chat session 106 and other chat sessions. When hardware hosting, a computing device (such as a server or a user device) can provide resources such as memory, communication, and execution resources for execution of instructions.

The bot application 104 can interface with a payment system 116 to provide instructions to the payment system 116 and receive financial information regarding users from the payment system 116. The payment system 116 can provide financial services, such as a fund transfer (e.g., a transfer of a certain monetary amount), to users. The payment system 116 can include payment accounts, each of which can be associated with a user. For example, one user can be associated with a first payment account, and another user (e.g., the merchant 124) can be associated with a second payment account (e.g., a merchant payment account) at the payment system 116.

The payment system 116 can facilitate a fund transfer from the first payment account to the second payment account. The payment system 116 can receive instructions from the bot application 104 to transfer money from a payment account that is linked with a first chat account (i.e., with a first user) to another payment account that is linked with another chat account (i.e., with another user or a merchant 124). The payment system 116 can be implemented by PAYPAL or another online payment system that allows users to send, accept, and request fund transfers.

The merchant 124 can be a business that provides goods or services to users. The merchant 124 can have an online store 122 that facilitates business activity online, e.g., on the Internet. The online store 122 can provide functionality for a user to configure a product or a service, and/or place the product or service in a cart to order the product or service. The online store 122 can provide functionality for the user to select a type of payment for the cart, and to submit the payment such that the products in the cart can be shipped to a shipping address specified by the user, or to schedule the service. The online store 122 can receive the payment from the payment system 116. The merchant 124 can have a payment account at the payment system 116, and thus can receive the payment as a transfer of funds from a buyer's payment account to the merchant payment account at the payment system 116.

In some embodiments, the online store 122 can receive the cart from the bot application 104. The bot application 104 can generate the cart and communicate the cart to the online store 122 for processing. The online store 122 can process the cart by authorizing the order(s) in the cart, by processing the payment for the cart, and/or by initiating shipping for the product(s) of the cart. As discussed herein, the existing user (e.g., the user of the (existing) user device 114(1)) can assist the new user (e.g., the user of the (new) user device 114(2)), via the chat session 106, with generating the cart, with processing of the payment, and with providing appropriate shipping information for the new user.

In the example illustrated in FIG. 1, the payment system 116 interfaces with one or more financial institutions, such as a financial institution 118(1) and a financial institution 118(2) (referred to collectively as financial institutions 118). Financial institutions 118 can provide financial services to users. Financial institutions 118 can be implemented as banks, credit unions, other deposit-taking institutions that accept and manage deposits and make loans, and other financial service providers. In some embodiments, financial institutions 118 can include credit card networks, e.g., for funding transfer of money between users. In some embodiments, financial institutions 118 may include a provider of purchasing power that is associated with a loyalty program. In one embodiment, the payment system 116 can access funds associated with the first payment account (of the payment system 116) by accessing the financial institution 118(1), and transfer these funds to a second payment account of the payment system 116 by accessing the financial institution 118(2).

The bot application 104 can determine a communication path that indicates how the authorization credentials will be provided to the bot application 104 from the user devices 114(1) and 114(2). The bot application 104 can determine the communication path based on the content of the chat texts received from the chat application instances 112(1) and 112(2). The bot application can receive primary authorization credentials from the new user device 114(2), and secondary authorization credentials from the existing user device 114(1). The primary authorization credentials can indicate that the new user authorizes the existing user to authorize the transaction that was initiated by the new user. The secondary authorization credentials can provide necessary authorization credentials needed for authorization of the transaction at the payment system 116. In some embodiments, a portion of the necessary authorization credentials can be provided by the primary authorization credentials, and another portion of the necessary authorization credentials can be provided by the secondary authorization credentials. In some embodiments, the bot application 104 can determine a different communication path for each of the primary and secondary authorization credentials.

In some embodiments, the bot application 104 can use an authorization web page 130 to facilitate receiving of authorization credentials for authorizing a transaction initiated by the new user (of the user device 114(2)). The authorization web page 130 can be hosted by a server 132. The bot application 104 can provide a link (e.g., via the chat session 106, or via email) to the authorization web page 130 with prompts for input of authorization credentials from the existing user (i.e., the user of the user device 114(1)) and the new user (i.e., the user of the user device 114(2)). The server 132 can then transmit both authorization credentials to the bot application 104. For example, the server 132 can transmit a notification to the bot application 104 indicating that the authorization web page 130 has received primary authorization credentials from the UI 120(1) and secondary authorization credentials from the UI 120(2).

In some embodiments, the bot application 104 can receive the authorization credentials for authorizing the transaction initiated by the new user (of the user device 114(2)) via the chat session. Thus, the bot application 104 can receive both the primary and the secondary authorization credentials as provided via chat texts (by the chat application instances 112(1) and 112(2)) at the chat session 106. In some embodiments, the primary authorization credentials can be provided to the bot application 104 from the chat application instance 112(2) via the chat session 106, and the secondary authorization credentials can be provided to bot application 104 via the authorization web page 130. In some embodiments, the secondary authorization credentials can include a password hint for the authorization credentials for the new user. The bot application 104 can use the authorization credentials received from the authorization web page 130 to authorize the new transaction. For example, the authorization web page 130 can provide a prompt to receive the primary and secondary authorization credentials.

For example, the transaction can be onboarding of the new user at the payment system 116. In this case, the primary authorization credentials can indicate to the bot application 104 that a portion of the authorization credentials for onboarding the new user (of the user device 114(2)) be received from the user device 114(1), as the new user trusts the existing user. The secondary authorization credentials (provided by the user device 114(1)) can be the portion of the authorization credentials that are required by the payment system 116 to onboard the new user.

In another example, the transaction can be an online purchase, initiated at the new user device 114(2), to be made at the online store 122 of the merchant 124. In this case, the primary authorization credentials can indicate to the bot application 104 that a portion of purchase selection and/or payment options will be received from the user device 114(1), as the new user trusts the existing user. The secondary authorization credentials can then provide details on the purchase at the online store 122. The secondary authorization credentials can provide payment details for the purchase, such as credentials for the online store to accept a payment from an account, at the payment system 116, of the new user.

In one embodiment, the bot application 104 can be implemented as a part of the payment system 116. For example, a server that hosts the payment system 116 can also host the bot application 104. The server can be implemented on a single computing device, or on multiple computing devices (e.g., using distributed computing devices or a cloud service). In another embodiment, the bot application 104 is separate from the payment system 116. The bot application 104 can instantiate the chat bot 102, as well as other chat bots.

The bot application 104 can access, via the chat bot 102, chat texts in the chat session 106. The chat texts are provided to the chat session 106 by the chat application instances 112. The chat application instance 112(1) can be associated with a first chat account, and the chat application instance 112(2) can be associated with a second chat account. The bot application 104 can determine whether the chat texts indicate the onboarding intent for onboarding the new user at the payment system 116. The bot application 104 can also determine whether the chat texts indicate a purchase intent, i.e., intent (by one of the chat application instances) to purchase a product (or a service) from the merchant 124.

For example, the bot application 104 can perform natural language processing (NLP) on a chat text that is provided by the chat application instance 112(1). Based on the NLP, the bot application 104 can determine whether the new user intends to be onboarded at the payment system 116, or purchase an item from the online store 122 that is discussed in the chat texts. The bot application 104 can also perform other analysis, such as search for certain text strings that indicate intent for onboarding, including “new account,” “novice user,” “want,” “need,” and others. The bot application 104 can search for certain text strings that indicate intent to purchase, including “buy,” “purchase,” “want,” “need,” and others. In some embodiments, bot application 104 may utilize various customized dictionaries for the NLP based on the user, user device, chat application, etc. In some embodiments, different customized dictionaries, or different customizations of a particular dictionary, may be utilized for the same user (e.g., based on the chat application, user device, or other factor). Accordingly, the NLP performance may be optimized based on various factors.

A payment account may be linked with a chat account when the bot application 104 includes an association between the chat account at the chat service 108, and the payment account at the payment system 116, both for the same user. In one embodiment, a payment account is linked with a chat account when the bot application 104 can also access configuration information for the chat account at the chat service 108 and/or for the payment account at the payment system 116, both for the same user. For a payment (e.g., for an online purchase) between a user of the user device 114(2) and the merchant 124, the bot application 104 can perform a fund transfer between the payment account linked to the chat account for that new user and a merchant payment account.

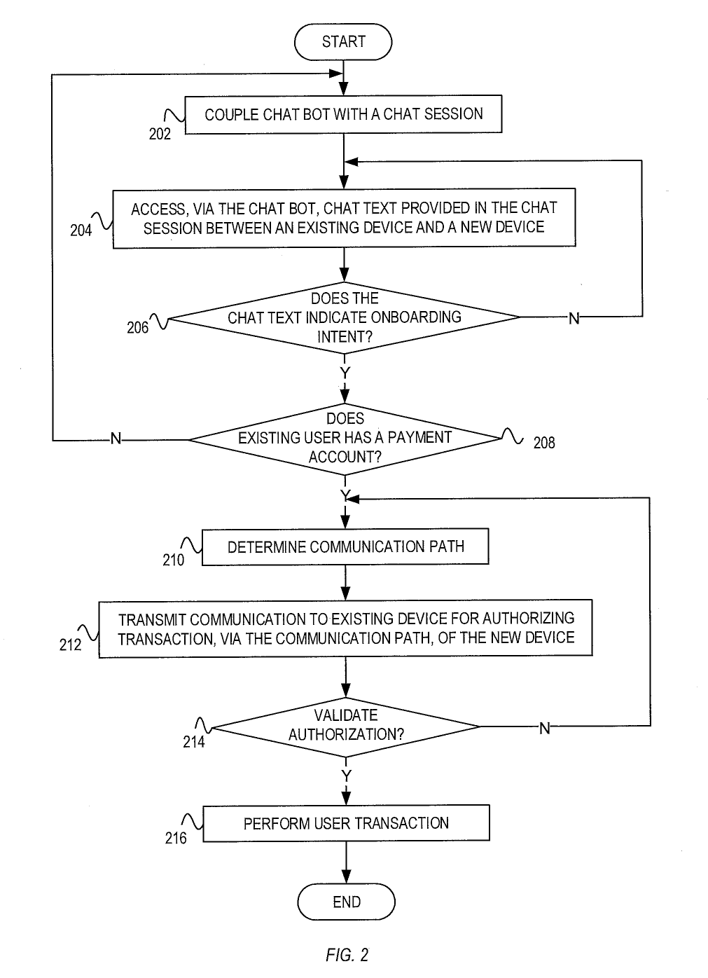

FIG. 2 is a flow diagram illustrating embodiments of operations for accessing chat sessions for cart generation. The method of FIG. 2 is described with reference to the systems and components described in FIG. 1 (for illustration purposes and not as a limitation). The example operations can be carried out by the bot application 104.

Beginning with 202, a chat bot is coupled with a chat session. For example, the chat bot 102 can be coupled with the chat session 106. In some cases, multiple chat bots can be coupled with multiple chat sessions. For example, the chat bot 102 can also couple with additional chat sessions (not shown) that may be provided by the social media service 110 and/or another social media service(s) (not shown). Coupling of a chat bot with a chat session can include registering with a chat session and configuring the chat bot for communication using the chat session.

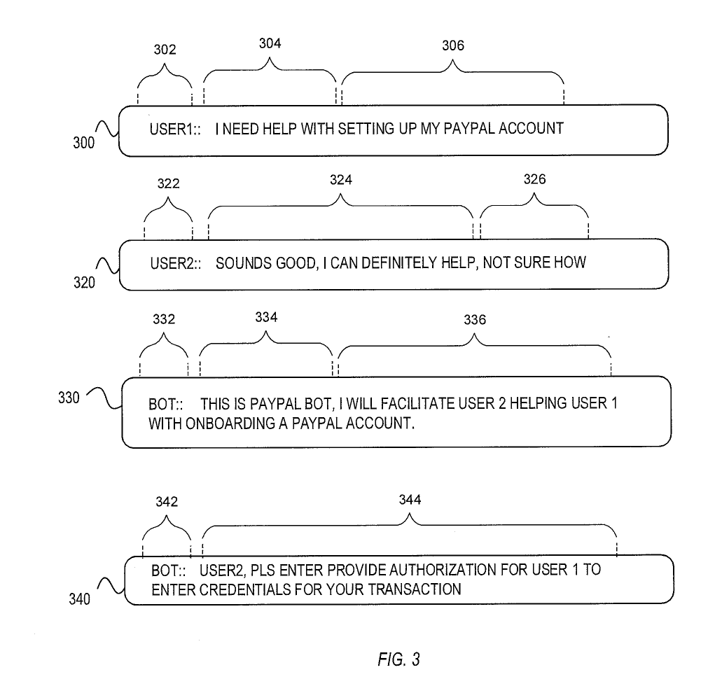

At 204, the bot application accesses, via the chat bot, a chat text provided in the chat session. For example, the bot application 104 can access, via the chat bot 102, chat text provided in the chat session 106. With reference to FIG. 3, the content of the chat text 300 and the chat text 320 can be accessed by the bot application 104.

At 206, the bot application determines whether the chat text(s) indicate onboarding intent. For example, the bot application 104 can analyze the chat text(s) between the chat application instances 112(1) and 112(2) and determine onboarding intent by the new user to set up a new account at the payment system 116. In one embodiment, the bot application 104 can provide chat text(s) to the chat session 106 requesting confirmation of the onboarding intent.

In some embodiments, the bot application 204 can apply natural language processing (NLP) to the chat text(s) to determine an interest level onboarding a new account (or an interest in a product (or service) offered by the merchant 124, as discussed below) by the user of the chat application instance 112(1). The bot application 204 can determine whether the interest level is greater than an interest threshold. If the bot application 204 determines that the interest level is greater than the interest threshold, the bot application 204 can determine that the chat application instance 112(1) has indicated the onboarding intent. An interest threshold can define an amount of interest level needed to start onboarding. The interest threshold can be a value that is predetermined, or that is determined dynamically, such as based on a frequency certain text strings are mentioned in the chat text(s).

In some embodiments, the bot application 104 can determine the onboarding intent by recognizing particular characters, words, phrases, patterns, emojis, and/or other symbols within the chat texts. The bot application 104 can analyze the chat texts for determining onboarding intent by searching for certain text strings that can indicate the onboarding intent. If the bot application 104 finds certain text strings in the chat session 106 provided by the chat application instance 112(1), the bot application 104 can determine that the chat application instance 112(1) has indicated the onboarding intent. If the bot application determines the onboarding intent from the chat texts, the flow continues at 208, otherwise the flow continues at 204 (where additional chat texts provided in the chat session can be accessed and continually monitored).

At 208, once the bot application has determined the intent to onboard the new user, the bot application determines whether the existing user has an account at the payment system. Alternatively, the bot application 104 can determine whether the existing user has an account at one of the financial institutions 118(1) and/or 118(2). Alternatively, the bot application 104 can determine whether the existing user has an account at the server 132 that provides the authorization web page 130. Thus, the bot application 104 can determine whether the existing user has an account at one of trusted systems that provide authorization. If the bot application 104 determines that the existing user has an account at the payment system (or at another trusted system), the flow continues at 210, otherwise the flow continues at 202 (where the chat bot can couple with another chat session with another existing user that may have an account at one of the trusted systems.).

At 210, the bot application determines a communication path for obtaining authorization credentials from the first user device for the user transaction. The communication path can be selected from using the chat session 106, an authorization web page 130, email, instant messaging (IM), among others. The bot application 104 can determine the communication path based on requirements of the payment system 116, on the content of the chat text(s) between the chat application instances 112(1) and 112(2), and/or any direct messages (DMs) between the chat application instance 112(2) and the bot application 104. In some embodiments, the communication path is automatically determined as a default communication for a certain type of a payment system.

In some embodiments, the bot application 104 can determine the communication path based on a user relationship between the existing user and the new user. For example, the user relationship can indicate a level of trust between the two users. The user relationship can be a family relationship, such as where the existing user is a son/daughter of a new user. The user relationship can be a fiduciary relationship, such as where existing user and the new user have an employer-employee relationship, or a certain contractual relationship.

At 212, the bot application transmits the communication to the new user device, the communication prompting the new user device to provide authorization to the chat bot for obtaining authorization credentials from the existing user device for the user transaction. With reference to FIG. 1, the bot application 104 can transmit communication to the user device 114(2). The communication can be transmitted via the chat session, email, DM, IM, among others. The communication prompts the user device 114(2) to provide authorization via the communication path (as determined at 210).

Depending on the selected communication path, the communication can prompt the new device and/or the existing device to provide authorization to the chat bot via the chat session. In another case, the communication can prompt the new device and/or the existing device to provide authorization via a link to the authorization web page. The bot application 104 can wait on a notification indicating that the authorization web page 130 has received the authorization credentials from the new user device and corresponding secondary authorization credentials from the existing user device. The bot application 104 can, responsive to receiving the notification, authorize the user transaction. The bot application 104 can, via the chat bot 102 and responsive to the authorizing of transaction, provide an indication of authorization to the chat session 106.

At 214, the bot application determines whether to validate the authorization. The validation can be performed as a final check prior to performing the transaction initiated by the new user. The bot application 104 can determine whether the received authorization credentials are valid. In some embodiments, the bot application 104 can access social information for the existing user and/or for the new user. The bot application 104 can determine, based on a risk analysis using the social information, whether to validate the authorization of the user transaction. For example, the bot application 104 can access social networks of each of the users of the user devices 114(1) and 114(4) to determine whether the social history of each of the users indicates a high-risk individual. Based on this high risk, the bot application 104 can determine not to validate the authorization, and thus the transaction will not be performed.

In some embodiments, the bot application 104 can determine, based on a risk analysis using the geographical location(s) of the user device(s), whether to validate the authorization of the user transaction. The bot application 104 can determine the geographical locations based, for example, on the response from the existing user device authorizing the transaction. For example, if a geographical location of either of the user devices 114(1) and 114(2) indicates a restricted area (such as located in a country that is restricted by an Office of Foreign Assets Control (OFAC)), the bot application 104 can determine not to validate the authorization, and thus the transaction will not be performed.

In some embodiments, the bot application 104 can monitor user activity in the chat session, such as new user activity from the chat application instance 112(2). The bot application 104 can monitor the user activity after the authorization has been received (e.g., via the chat session 106 and/or via the authorization web page 130). If the new user activity at the chat session 106 is low (e.g., below an activity threshold), and the transaction has not been finalized (e.g., there is still some information related to the transaction that need to be received from the new user device 114(2)), the bot application 104 can determine additional onboarding intent for the new user. The activity threshold can define an amount of activity above which the user does not need additional help with onboarding. If the additional onboarding intent is determined, the bot application can perform steps 210-214 again until the user transaction can be finalized.

If the bot application determines that the user transaction is validated, the flow continues at 216, otherwise the flow continues at 210. At 216, the bot application performs and thus finalizes the user transaction. In the above description, the onboarding embodiments of FIG. 2 are described. In some embodiments, the user transaction can be an online purchase at the online store 122 of the merchant 124.

For the online purchase embodiments, the operation of the flowchart of FIG. 2 is similar to the onboarding embodiments, with some variations as discussed below. In some embodiments, the online purchase transaction can be performed by the same new user as the onboarding transaction. Thus, after the bot application 104 onboards the new user, the bot application 104 can then facilitate the existing user's assistance for the online purchase transaction of the new user. At 206, the bot application can determine whether the chat text indicates purchase intent. For example, the bot application 104 can determine whether chat texts between the chat application instances 112(1) and 112(2) indicate intent by the new user to purchase a product (or service) discussed in the chat texts. The bot application 104 can also determine some product features of the online purchase by from the chat texts.

The bot application 104 can access a product webpage at the online store 122. The bot application 104 can generate, based on the product features and the chat texts, a cart for an order of the product from the merchant's online store 122. The bot application 104 can generate the cart at the payment system 116 or at the online store 122. The chat texts can provide additional information about the product, such as via the chat texts where the new user indicates features of the product. If the bot application 104 generates the cart at the payment system 116, the payment system 116 can generate a token, such as an order token. The token can be used for associating the cart at the payment system 116 with the chat applicant instance 112(1) and the merchant 124.

The authorization credentials that are provided by the existing user can include purchasing details that the new user is unable, or has difficulty with, providing. For example, the authorization credentials provided from the existing user device 114(1) can include payment options, the cart, and/or shipping information. The payment system 116 can communicate the generated cart to the online store 122, where the communication can be performed using the token. Any communication between the online store 122 and the payment system 116 using the token is authenticated, e.g., encrypted, secure, and between verified entities (i.e., the payment system 116 and the merchant 124). The authenticated communication can include communication by the payment system 116 providing the cart, and/or a payment for the cart, to the online store 122. In some embodiments, the payment system 116 can generate the token prior to the payment system 116 linking the user payment account with a chat account of the chat application instance 112(1). In some embodiments, the user payment account at the payment system 116 can be linked with the chat account for the chat application instance 112(1) prior to the payment system 116 generating the token.

In some embodiments, the onboarding transaction (or the online purchase transaction) can be performed for multiple new users. For example, the existing user can assist two new users (e.g., both family members of the existing user) with the onboarding of their respective new accounts. In this case, the existing user can provide respective secondary authorization credentials for each of the new accounts. Similarly, the existing user can assist two existing users with their respective online purchase transactions.

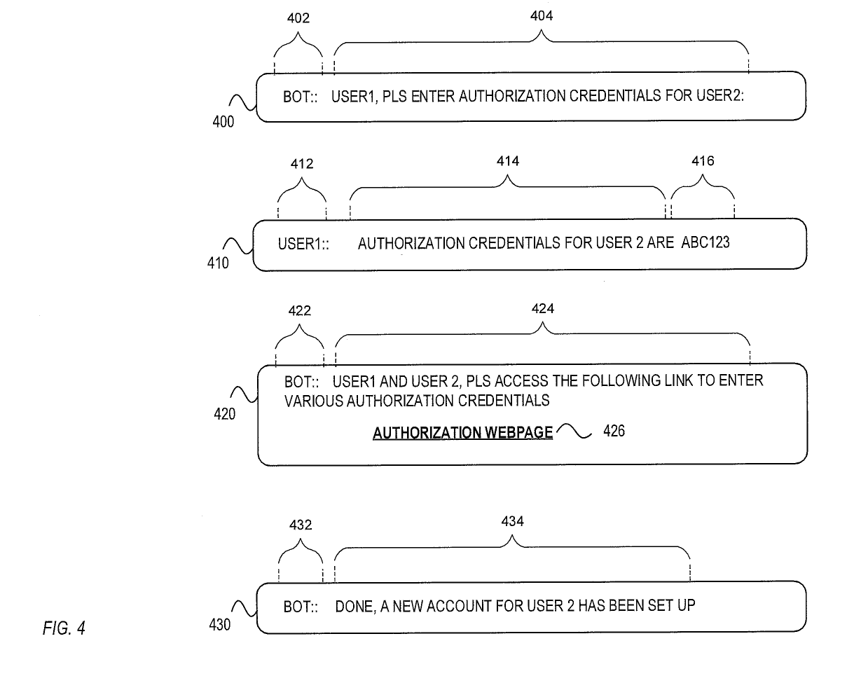

FIGS. 3 and 4 illustrate embodiments of communication for accessing chat sessions for multi-user authorization of user transactions via a chat bot. With reference to FIG. 3, chat text 300 illustrates a chat text that can be provided, by the chat application instance 112(1), to the chat session 106. Chat text 320 illustrates a chat text that can be provided, by the chat application instance 112(2), to the chat session 106. Chat texts 330 and 340 illustrate chat texts that can be transmitted, via the chat bot 102 of the bot application 104, to the chat session 106.

The chat text 300 can include chat text portions (also referred to as “portions”) 302-306. The bot application 104 can access, via the chat bot 102, the chat text 300 and parse the various portions 302-306, such as to determine intent of the user. The bot application 104 can similarly access and parse portions of, the chat texts 320 and 330 (e.g., portions 322-326 and 332-336, respectively). In the depicted example embodiments, the portion 302 of “user1:” indicates that the chat application instance 112(1) is transmitting the chat text 300. The portion 304 of “I need help with” can indicate (e.g., as parsed and determined by the bot application 104) interest by the new user. The portion 306 of “setting up my PayPal account” can indicate the payment system 116.

The chat text 320 can include portions 322, 324, and 326. The portion 322 of “user2:” indicates that the chat application instance 112(2) is transmitting the chat text 330. The portion 324 of “Sounds good, I can definitely help” can be used to determine interest by the existing user to assist the new user with the onboarding. The portion 326 of “not sure how” can be used to determine that the existing user has no preference of a communication channel via which the secondary authorization credentials can be provided.

The chat text 330 can include portions 332, 334, and 336. The portion 332 of “bot:” indicates that the chat bot 102 is transmitting the chat text 330. The portion 334 of “This is PayPal bot” indicates source of the chat text 330 to the new and existing users. The portion 336 of “I will facilitate user 2 helping user 1 with onboarding a PayPal account” indicates to the users that the multi-user authorization of the new user's transaction will begin.

The chat text 340 can include portions 342 and 344. The portion 342 of “bot:” indicates that the chat bot 102 is transmitting the chat text 340. The portion 344 of “User 2, please provide authorization for user 1 to enter credentials for your transaction” indicates to the new user to authorize the existing user to provide secondary authorization credentials to authorize the new user's transaction.

With reference to FIG. 4, chat texts 400, 420, and 430 illustrate chat texts that can be transmitted by the bot application 104, via the chat bot 102, to the chat session 106. Chat text 410 illustrates a chat text that can be provided, by the chat application instance 112(1), to the chat session 106.

The chat text 400 includes portions 402 and 404. In the depicted example embodiment, the portion 402 of “bot:” indicates that the chat bot 102 is transmitting the chat text 400. The portion 404 of “User 1, pls enter authorization credentials for user 2” prompts the existing user to provide authorization credentials for the transaction of the new user. The chat text 400 indicates that the bot application 104 has selected the chat session 106 as the communication path via which the bot application 104 will receive the secondary authorization credentials (as illustrated by the chat text 410).

The chat text 410 includes portions 412-416. The portion 412 of “user1:” indicates that the chat application instance 112(1) is transmitting the chat text 410. The portion 414 of “Authorization credentials for user 2 are” indicates to the bot application 104 that the chat text 410 includes the secondary authorization credentials. The portion 416 of “ABC123” are the secondary authorization credentials for the user transaction of the new user, as transmitted via the chat session communication path.

The chat text 420 includes portions 424-426. The portion 422 of “bot:” indicates that the chat bot 102 is transmitting the chat text 420. The portion 424 of “User 1 and user 2, please access the following link to enter various authorization credentials” is generated by the bot application 104 to give instructions to the new and existing users to enter the authorization credentials. The portion 426 of “Authorization Webpage” can be a link to the authorization webpage 130. In some embodiments, only one of the chat texts 400 or 420 are provided to the chat session 106. The chat text 420 indicates that the bot application 104 has selected the authorization webpage 130 as the communication path via which the bot application 104 will receive the secondary authorization credentials.

The chat text 430 can include portions 432 and 434. The portion 432 of “bot:” indicates that the chat bot 102 is transmitting the chat text 430. The portion 434 of “Done, a new account for user 2 has been set up” indicates that the bot application 104 has successfully performed the onboarding transaction of the new user.

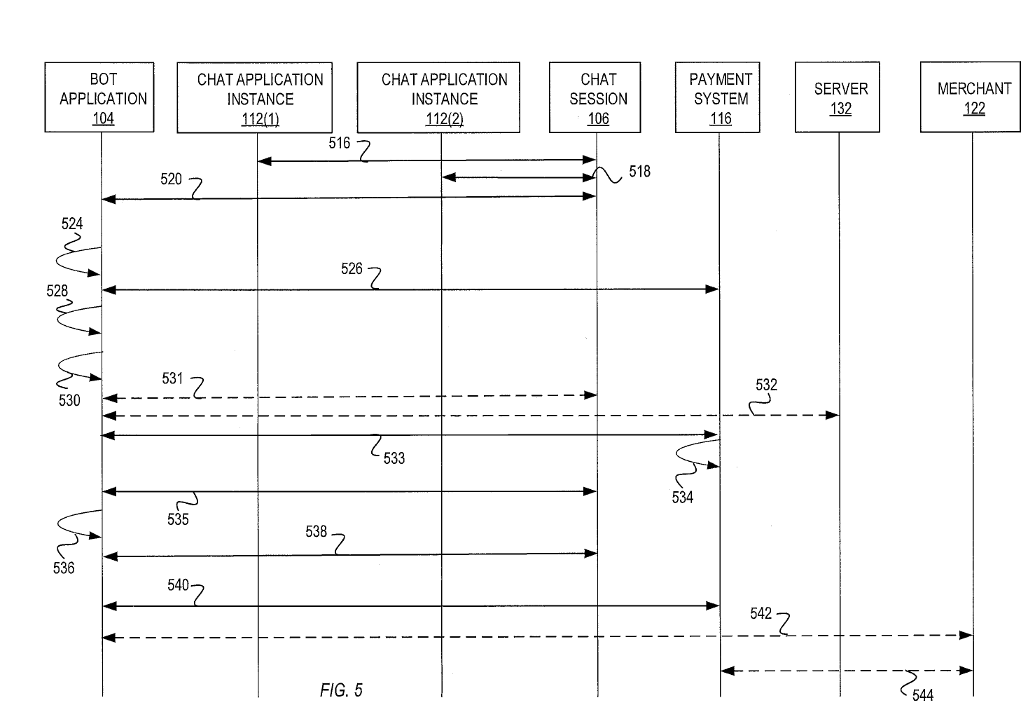

FIG. 5 is a timing diagram illustrating one embodiment of communication between a bot application and chat application instances via a chat session for using multi-party authorization of user transactions initiated at a single user device. As shown by FIG. 5, the bot application 104 communicates, via a chat bot (not shown), with the chat application instances 112(1) and 112(2) using the chat session 106. The bot application 104 also communicates with the payment system 116 and the merchant 124. The communications of FIG. 5 can be performed over one or more communication networks. Portions of the timing diagram of FIG. 5 correspond to the flow diagram of FIG. 2.

At 516, the chat application instance 112(1) provides a chat text to the chat session 106. The chat text at 516 can include at least a portion of the contents of the chat text 300. At 518, the chat application instance 112(2) provides a chat text to the chat session 106. The chat text at 518 can include the contents of the chat text 320. At 520, the bot application 104 can access the chat texts of 516 and/or 518. At 524, the bot application 104 can determine onboarding intent based on analysis of the chat texts of 516 and/or 518. At 526, the bot application 104 can, in response to determining the onboarding intent, access the payment system 116 to access user account data for the new user and/or existing user. At 528, the bot application 104 can determine, based on the access at 526, whether the existing user has an account at the payment system 116. At 530, the bot application 104 can determine the communication path for obtaining authorization credentials from the first user device (via the chat application instance 112(1)) for the onboarding user transaction. At 531, the bot application 104 can access the chat session 106, if the authorization credentials are provided via the chat session 106. At 532, the bot application 104 can access the server 132, if the authorization credentials are provided via the authorization web page 130. At 533, the bot application 104 provides the authorization credentials to the payment system 116. At 534, the payment system can perform the authorized transaction.

At 535, the bot application 104 can access an additional chat text from the chat application instance 112(2) (not shown). At 536, the bot application 104 can determine purchase intent (of the new user) based on analysis of the additional chat text. At 536, the bot application can also determine the communication path for obtaining authorization credentials from the first user device (via the chat application instance 112(1)) for the online shopping transaction. At 538, the bot application 104 can access authorization credentials that were provided by the chat application instance 112(2) in response to determining the chat session as the communication path. At 540, the bot application 104 can access the payment system to authorize the online shopping transaction. At 542, the bot application 104 can provide the order for the online shopping transaction on behalf of the new user. At 544, the payment system 116 can provide an indication to the merchant 132 that the payment has been processed (e.g., funds for the payment have been transferred from the payment account of the new user linked with the chat application instance 112(2) to the merchant's payment account).

It should be understood that FIGS. 1-5 and the operations described herein are examples meant to aid in understanding embodiments and should not be used to limit embodiments or limit scope of the claims. Embodiments may perform additional operations, fewer operations, operations in a different order, operations in parallel, and some operations differently. For example, one or more elements, steps, or processes described with reference to the diagrams of FIGS. 2 and 5 may be omitted, described in a different sequence, or combined as desired or appropriate.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible and/or non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Computer program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The computer program code may execute (e.g., as compiled into computer program instructions) entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flow diagram illustrations and/or block diagrams of methods, apparatus (systems) and computer program products according to embodiments of the present disclosure. It will be understood that each block of the flow diagram illustrations and/or block diagrams, and combinations of blocks in the flow diagram illustrations and/or block diagrams, can be implemented by computer program instructions. These computer program instructions may be provided to a processor of a general purpose computer, special purpose computer, or other programmable data processing apparatus to produce a machine, such that the computer program instructions, which execute via the processor of the computer or other programmable data processing apparatus, create means for implementing the functions/acts specified in the flow diagrams and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flow diagrams and/or block diagram block or blocks.

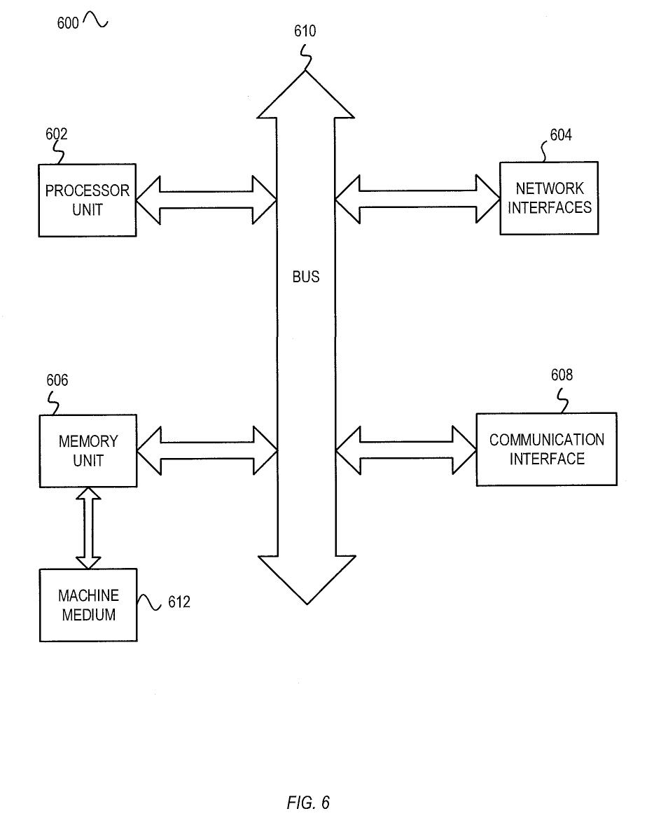

FIG. 6 is a block diagram of an exemplary embodiment of an electronic device 600 including a communication interface 608 for network communications. The electronic device can embody functionality to implement embodiments described in FIGS. 1-5 above. In some implementations, the electronic device 600 may be a laptop computer, a tablet computer, a mobile phone, a powerline communication device, a smart appliance (PDA), a server, and/or one or more another electronic systems. For example, a user device may be implemented using a mobile device, such as a mobile phone or a tablet computer. For example, a payment system may be implemented using one or more servers. The electronic device 600 can include a processor unit 602 (possibly including multiple processors, multiple cores, multiple nodes, and/or implementing multi-threading, etc.). The electronic device 600 can also include a memory unit 606. The memory unit 606 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 600 can also include the bus 610 (e.g., PCI, ISA, PCI-Express, HyperTransport®, InfiniBand®, NuBus, AHB, AXI, etc.), and network interfaces 604 can include wire-based interfaces (e.g., an Ethernet interface, a powerline communication interface, etc.). The communication interface 608 can include at least one of a wireless network interface (e.g., a WLAN interface, a Bluetooth interface, a WiMAX interface, a ZigBee interface, a Wireless USB interface, etc.), In some implementations, the electronic device 600 may support multiple network interfaces—each of which is configured to couple the electronic device 600 to a different communication network.

The memory unit 606 can embody functionality to implement embodiments described in FIGS. 1-5 above. In one embodiment, the memory unit 606 can include one or more of functionalities that facilitate communicating in chat sessions using chat bots for multi-user authorization of user transactions. Any one of these functionalities may be partially (or entirely) implemented in hardware and/or on the processor unit 602. For example, some functionality may be implemented with an application specific integrated circuit, in logic implemented in the processor unit 602, in a co-processor on a peripheral device or card, etc. Further, realizations may include fewer or additional components not illustrated in FIG. 6 (e.g., video cards, audio cards, additional network interfaces, peripheral devices, etc.). The processor unit 602, the memory unit 606, the network interface 604 and the communication interface 608 are coupled to the bus 610. Although illustrated as being coupled to the bus 610, the memory unit 606 may be coupled to the processor unit 602.

While the embodiments are described with reference to various implementations and exploitations, it will be understood that these embodiments are illustrative and that the scope of the present disclosure is not limited to them. In general, techniques for using chat bots as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the present disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present disclosure.

What is claimed is:

1. A method for initiating multi-user authorization of user transactions via chat sessions, the method comprising:
accessing, via a chat bot, a first chat text provided in a chat session by a first chat application instance hosted by a first user device to a second chat application instance hosted by a second user device, the chat session hosted by a chat service to facilitate communication between chat application instances;
determining, based on an analysis of the first chat text, an onboarding intent of a user transaction originating at the second user device, the onboarding intent indicating that the user transaction be performed at a payment system;
in response to determining the onboarding intent, determining whether an existing user associated with the first chat application instance has an existing payment account at the payment system; and
in response to a determination that the existing user has the existing payment account, transmitting a communication to the second user device, the communication prompting the second user device to provide authorization to the chat bot for obtaining authorization credentials, from the first user device, for the user transaction of the second user device.

2. The method of claim 1, further comprising:
determining, based on a user relationship between the existing user and a new user associated with the second user device, a communication path for the communication, wherein the communication path is selected from a transmission via a direct message between the chat bot and the second user device or a transmission via the chat session, wherein the communication is transmitted via the chat session in response to a determination of the communication path via the chat session.

3. The method of claim 1, further comprising:
determining a first geographical location of the first user device;
determining a second geographical location of the first user device; and
determining, based on a risk analysis using the first geographical location and the second geographical location, whether to validate the authorization of the user transaction from the first user device.

4. The method of claim 1, further comprising:
accessing first social information for the existing user;
accessing second social information for a new user associated with the second user device; and
determining, based on a risk analysis using the first social information and the second social information, whether to validate the authorization of the user transaction from the first user device.

5. The method of claim 1, wherein
the communication prompting the second user device to provide authorization to the chat bot comprises prompting the second user device to provide authorization to the chat bot via the chat session.

6. The method of claim 1, wherein
the communication prompting the second user device to provide authorization to the chat bot comprises prompting the second user device with a link to an authorization web page for the authorization.

7. The method of claim 6, further comprising:
waiting on a notification indicating that the authorization web page has received the authorization credentials from the first user device and corresponding secondary authorization credentials from the second user device;
responsive to receiving the notification, authorizing the user transaction; and
responsive to the authorizing of the user transaction, providing an indication of authorization to the chat session.

8. The method of claim 1, further comprising:
monitoring the chat session to determine activity of a new user associated with the second user device; and
determining, based on the activity of the new user, whether assistance is required prior to authorizing the user transaction.

9. The method of claim 1, wherein
the user transaction is a purchase transaction originating at the second user device to an online merchant; and
the communication comprises purchasing details for accessing a webpage of the online merchant.

10. The method of claim 1, wherein
the user transaction is an onboarding transaction originating at the second user device for onboarding a new user, onto the payment system; and
the communication comprises a password hint for the authorization credentials of the new user.

11. A system comprising:
a non-transitory memory storing instructions; and
a processor configured to execute the instructions to cause the system to:
access, via a chat bot, a first chat text provided in a chat session by a first chat application instance hosted by a first user device to a second chat application instance hosted by a second user device, the chat session hosted by a chat service to facilitate communication between chat application instances;
determine, based on an analysis of the first chat text, an onboarding intent of a user transaction originating at the second user device, the onboarding intent indicating that the user transaction be performed at a payment system;
in response to determining the onboarding intent, determine whether an existing user associated with the first chat application instance has an existing payment account at the payment system; and
in response to a determination that the existing user has the existing payment account, transmit a communication to the second user device, the communication prompting the second user device to provide authorization to the chat bot for obtaining authorization credentials, from the first user device, for the user transaction of the second user device.

12. The system of claim 11, wherein executing the instructions further causes the system to,
determine, based on a user relationship between the existing user and a new user associated with the second user device, a communication path for the communication, wherein the communication path is selected from a transmission via a direct message between the chat bot and the second user device or a transmission via the chat session, wherein the communication is transmitted via the chat session in response to a determination of the communication path via the chat session.

13. The system of claim 11, wherein
the communication prompting the second user device to provide authorization to the chat bot comprises prompting the second user device to provide authorization to the chat bot via the chat session.

14. The system of claim 11,
wherein the communication prompting the second user device to provide authorization to the chat bot comprises prompting the second user device with a link to an authorization web page for providing of the authorization;
wherein executing the instructions further causes the system to,
wait on a notification indicating that the authorization web page has received the authorization credentials from the first user device and corresponding secondary authorization credentials from the second user device;
responsive to receipt of the notification, authorize the user transaction; and
responsive to the authorization of the user transaction, provide an indication of authorization to the chat session.

15. The system of claim 11, wherein executing the instructions further causes the system to,
monitor the chat session to determine activity of a new user associated with the second user device; and
determine, based on the activity of the new user, whether assistance is required prior to authorizing the user transaction.

16. A non-transitory machine-readable medium having instructions stored thereon, the instructions executable to cause performance of operations comprising:
accessing, via a chat bot, a first chat text provided in a chat session by a first chat application instance hosted by a first user device to a second chat application instance hosted by a second user device, the chat session hosted by a chat service to facilitate communication between chat application instances;
determining, based on an analysis of the first chat text, an onboarding intent of a user transaction originating at the second user device, the onboarding intent indicating that the user transaction be performed at a payment system;
in response to determining the onboarding intent, determining whether an existing user associated with the first chat application instance has an existing payment account at the payment system; and
in response to a determination that the existing user has the existing payment account, transmitting a communication to the second user device, the communication prompting the second user device to provide authorization to the chat bot for obtaining authorization credentials, from the first user device, for the user transaction of the second user device.

17. The non-transitory machine-readable medium of claim 16, wherein the operations further comprise:
determining, based on a user relationship between the existing user and a new user associated with the second user device, a communication path for the communication, wherein the communication path is selected from a transmission via a direct message between the chat bot and the second user device or a transmission via the chat session, wherein the communication is transmitted via the chat session in response to a determination of the communication path via the chat session.

18. The non-transitory machine-readable medium of claim 16, wherein the operations further comprise:
the communication prompting the second user device to provide authorization to the chat bot comprises prompting the second user device to provide authorization to the chat bot via the chat session.

19. The non-transitory machine-readable medium of claim 16,
wherein the communication prompting the second user device to provide authorization to the chat bot comprises prompting the second user device with a link to an authorization web page for providing of the authorization;
wherein the operations further comprise:
wait on a notification indicating that the authorization web page has received the authorization credentials from the first user device and corresponding secondary authorization credentials from the second user device;
responsive to receipt of the notification, authorize the user transaction; and
responsive to the authorization of the user transaction, provide an indication of authorization to the chat session.

20. The non-transitory machine-readable medium of claim 16, wherein the operations further comprise:
monitor the chat session to determine activity of a new user associated with the second user device; and
determine, based on the activity of the new user, whether assistance is required prior to authorizing the user transaction.
